(19) United States
(12) Patent Application Publication
(10) Pub. No.: US 2002/0169628 A1
(43) Pub. Date: Nov. 14, 2002

(54) IT supported lock box delivery/distribution of goods

(75) Inventor: Ruediger Roland Bauer, Stuttgart (DE)

Correspondence Address: Jeffrey S. LaBaw, International Business Machines, Intellectual Property Law, 11400 Burnet Rd., Austin, TX, 78758, US

(73) Assignee: INTERNATIONAL BUSINESS MACHINES CORPORATION, ARMONK, NY

(21) Appl. No.: 10/104,727

(22) Filed: Mar. 21, 2002

(30) Foreign Application Priority Data
May 11, 2001 (EP) 01111521.9

(51) Int. Cl. G06F 17/60

(52) U.S. Cl. 705/1

(57) ABSTRACT

The disclosed method and system for delivery of goods, after an order being placed with an online store by an ordering party, comprises the steps of instructing a dispatcher to process delivery of the ordered goods, fetching the ordered goods from a storehouse by the dispatcher, dispatching the fetched goods to a locking device, providing a code number for accessing the locking device to the ordering party and transferring said code number to the locking device via a telecommunication channel, and fetching the ordered goods from the locking device by the ordering party at an arbitrary time using said code number. Further proposed is a locking device comprising a box combined with a releasing counter means, a lockable door which can be released electronically , a telecommunication line for providing a network or online connection to the online store, control means for handling information about pending orders locally, and converter means for interfacing between the lockable door and said control means and/or said telecommunication means.

### BACKGROUND OF THE INVENTION

The invention generally is in the field of goods distribution or delivery and more specifically relates to a method and system for information technology (IT) supported or implemented final delivery/distribution of goods or wares to an addressee.

A continuously increasing part of business-to-customer (B2C) transactions is accomplished via Internet based electronic commerce (eCommerce) or other online shopping channels like telephone ordering services. Goods and wares ordered by such online shopping services nowadays are delivered or distributed using common dispatching or forwarding agents like express or post mailing services.

Not only in the end consumer business but also in the arena of business-to-business (B2B) transactions, sometimes there is an according need to physically transfer offered goods or wares from one company to another company. Only exemplarily it is referred to information technology (IT) hardware equipment purchased by one company from an online seller of IT equipment like Dell Corp. or the present assignee.

The predescribed approaches for delivery or distribution of goods are disadvantageous insofar as the goods can not be delivered when the addressee or recipient is currently not available and thus can not receive the shipment, e.g. due to employment practicing. In these cases which are rather common these days the delivery of the goods is delayed, thus often increasing the costs for the goods delivery.

On the other hand, the addressee often has problems with the delivery services themselves as they often do not offer a 24-hour full-time service and thus the addressee is not able to obtain the shipment only by approaching the delivery service.

### SUMMARY OF THE INVENTION

It is therefore an object of the present invention to provide a mechanism for delivery/distribution of goods which avoids the above mentioned drawbacks of existing approaches.

It is another object to provide secure delivery/distribution of goods.

Another object is controlled and monitored delivery, particularly all around the globe.

Yet another object is to provide a low cost mechanism for delivery/distribution of goods.

These objects and other objects becoming evident from the following description are attained by the features of the independent claims. Advantageous embodiments are subject matter of the subclaims.

The basic idea underlying to the invention is an IT implemented intermediate delivery station such as a lock box or the like where a shipment or wares or goods can be stored intermediately before final delivery to the recipient. The delivery station can only be accessed or opened using a code number or likewise information for identification and authorization. The invention can advantageously be implemented as an eCommerce or Internet dispatcher service solution.

The invention provides a 24-hour delivery system which is independent from opening hours and independent of human intervention or support. It enables faster delivery as prior art approaches through prevention of mismatch between dispatcher and addressee. Since the proposed delivery service mechanism can be implemented fully automated by an unmanned hand over of the ordered goods to the recipient, considerable costs can be saved. In addition, the delivery service improves resend or reject capabilities for the recipient in case of a wrong delivery.

The invention embraces an according delivery service mechanism and system and a lock box design having implemented the necessary IT equipment, as described in more detail in the following. It can advantageously be applied to either Internet or eCommerce supported ordering services or paper or offline based catalog ordering services where orders get placed via postcard, fax, phone or Internet.

### BRIEF DESCRIPTION OF THE DRAWINGS

In the following, the invention is described in more detail by way of embodiments from which further features and advantages of the invention become evident.

FIG. 1 is an overview block diagram illustrating an eCommerce hardware and software environment in accordance with the invention;

FIG. 2 is a schematic front view illustrating functional Components of a lock box according to the invention;

FIG. 3 is an overview flow diagram illustrating the Basic data flow of an IT implemented final delivery service in accordance with the invention; and

FIG. 4a-d is a more detailed flow diagram illustrating an IT controlled 24 hour automated lock ox delivery process in accordance with the invention.

### DETAILED DESCRIPTION OF THE PREFERRED EMBODIMENTS

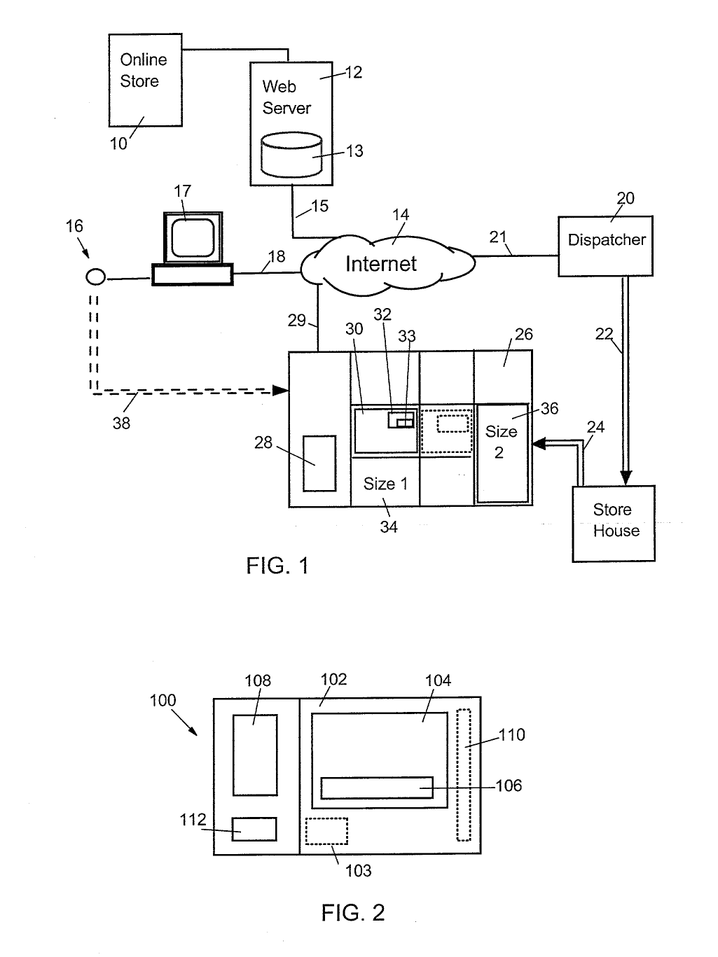

FIG. 1 shows a hardware and software arrangement or environment for performing an IT controlled goods delivery process in accordance with the present invention. An online store 10 offers articles via a Web server 12. The web server 12 includes a storage 13, e.g. a common hard disk device (HDD) or a HDD raid array, for storing at least application and communication programs, an online order database and a customer database. These databases can also be stored at other servers of the online store which are connected to the Web server 12. The Web server 12 is connected to the Internet 14 via telecommunication line 15.

An ordering party 16, e.g. an end consumer in case of a business-to-customer (B2C) transaction or a business partner in case of a business-to-business (B2B) transaction, in the present example uses a personal computer (PC) or workstation 17 that is connected to the Internet 14 by means of a common Internet Browser or a likewise application via telecommunication line 18. It is assumed that the ordering party 16 orders an article from the online store 10 via the Web server 12. The underlying business process or transaction is described in more detail in the following.

After a valid purchase order has been posted at an eCommerce application running on the Web server 12, the online store 10 or an underlying eCommerce application running on the Web server 12 instructs a dispatcher service 20 via telecommunication line 21 to further process the purchase order. The dispatcher 20 at first fetches the ordered article(s) from a storehouse 23 or the like and dispatches the fetched article(s) to a lock box in a lock box installation 26. The double lines 22 and 24 indicate that the fetching and dispatching require physical transfer of the article(s) from the storehouse 23 to the lock box installation.

The physical transfer itself can be a multi-step process in case the shipment is e.g. an intercontinental multi country distance.

The lock box installation 26 comprises a network connection device 28, e.g. a modem, a network adapter or the like, that connects each lock box of the installation 26 to the Internet via communication line 29. Each lock box comprises a lockable door 30 wherein the locking mechanism can be deactivated using a code number, as described in more detail hereinafter. It further comprises a touch screen display 32 with an integrated write field 33. The touch screen 32 provides a graphical user interface (GUI) that enables a user to query information about a purchase order online. The integrated write field 33 allows to input a written signature.

The lock box installation 26 includes lock boxes of different sizes, e.g. the lock boxes 34 and 36, to enable delivery of goods of different sizes.

After (an) ordered article(s) have been dispatched to a lock box 34, 36, the ordering party can obtain the article(s) from the lock box 34, 36 at an arbitrary time wherein the process of providing access to the lock box 34, 36 is described in detail hereinafter.

It is noted that the lock box installation, alternatively, can be implemented as an automatic-delivery apparatus like a mechanical seller where a number of lock boxes arranged on a carrousel, comprising a number of lockable doors in front of it, where the lock boxes become accessible due to rotation of the carrousel. Instead of using a carrousel, the boxes can be physically moved by means of a linear movable conveyer belt or the like.

In addition, the invention can also be used in an automated ware or store house where the ordering party can fetch purchased goods by entering the code number, wherein an automatic transport of the purchased goods by means of a palette or the like to the locked door is initiated and wherein the locked door is opened automatically or after a further action of the ordering party.

FIG. 2 shows a schematic front view of a single lock box 100 of a lock box installation 26 depicted in FIG. 1. The lock box 100 comprises a door 102 with an integrated display 104, preferably an LCD display with touch screen and/or write field 106 functionality for entering the code number and/or for inputting a written signature by the ordering party when fetching the ordered article(s) from the lock box. As mentioned above, the lock box further comprises a communication device or network adapter 108 for providing a network or online connection to the Web server 12 of the online store 10. Optionally, the lock box 100 can comprise a common cooling system 110 for cooling the inside of the lock box 100. Furthermore it can contain a card reader to read data from a credit card for authorization or/and for payment, a camera and or light barriers for size check for record of correct delivery for the dispatcher as well as for the vendor, an electronic libra for verification of correct delivery and a printer for printing a receipt.

In the shown embodiment, the dispatcher service uses a barcode reader which can be plugged into a corresponding socket 112 comprised by the lock box 100. Alternatively, a barcode reader can be attached to the lock box 100 or the lock box installation 26. When placing the article(s) in the lock box 100, the placed article(s) is (are) confirmed by reading the corresponding barcodes.

In another embodiment, the dispatcher service can confirm delivery of the article(s) by undersigning by date onto the write field 33. The lock box 100 then initiates the above-mentioned online connection via telecommunication line 29 to the online store 10 in order to inform the ordering party 16 that the ordered article(s) has (have) been dispatched to the particular lock box 34, 36.

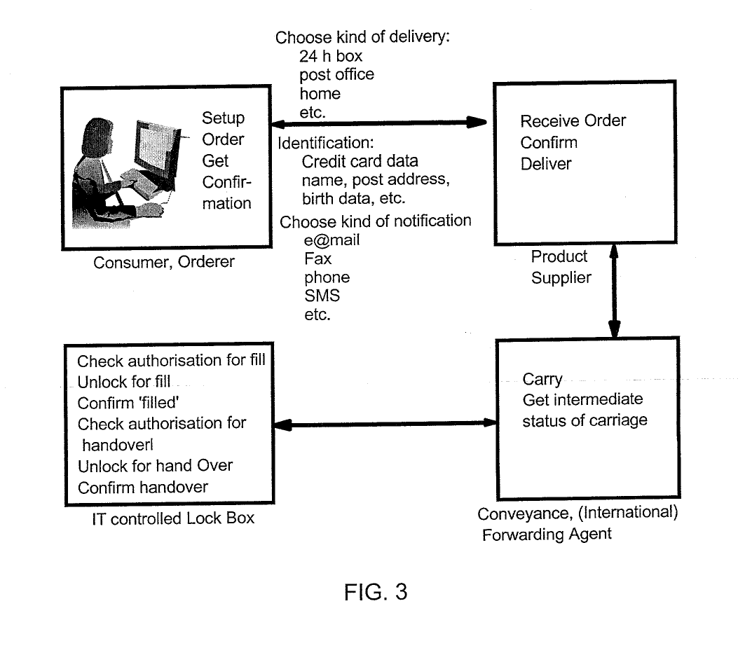

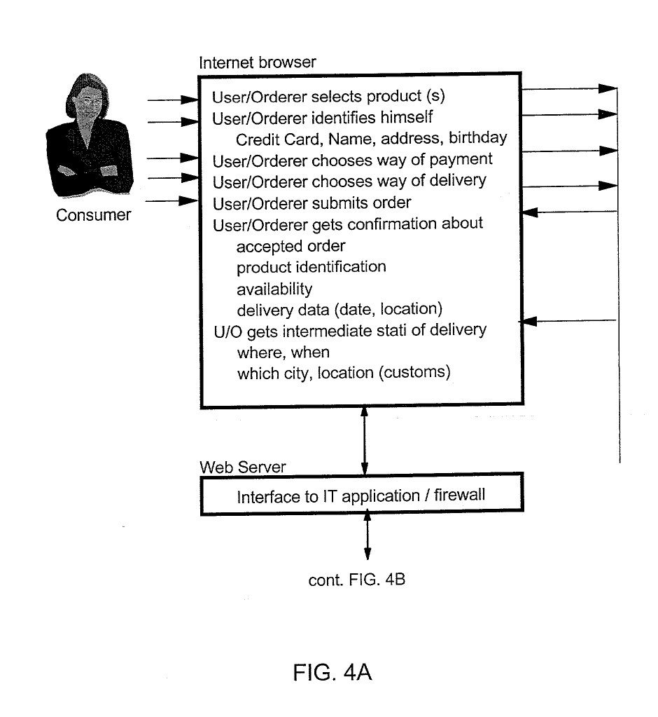

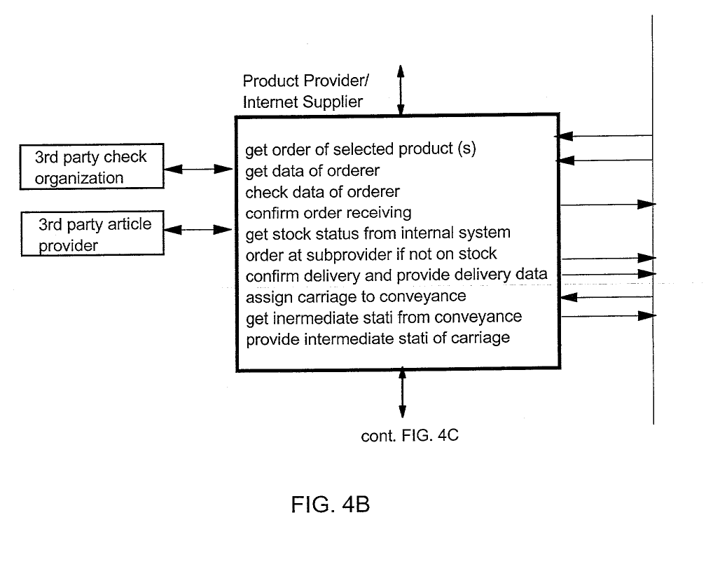

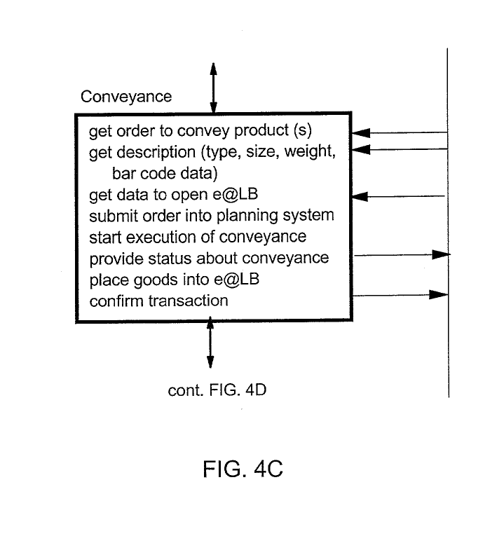

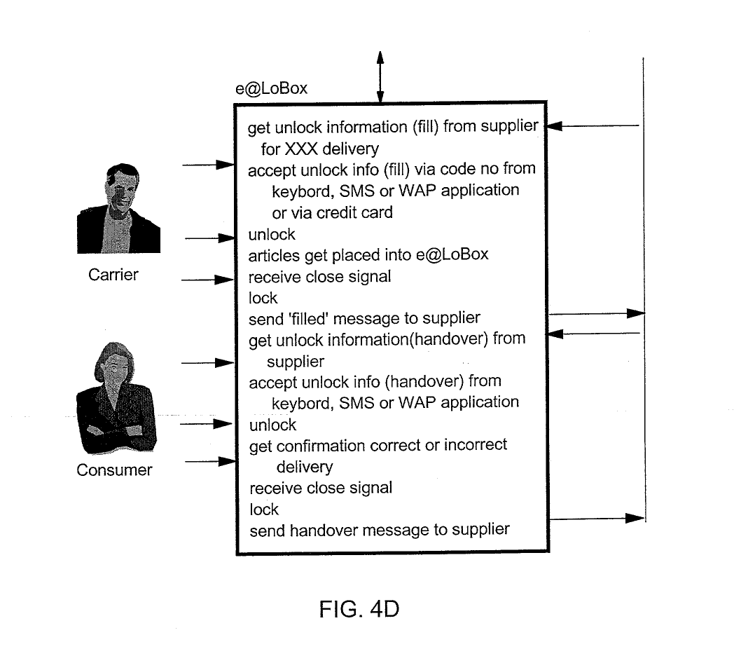

As described in more detail in the following referring to FIG. 3 and FIGS. 4a-4d, delivery of good(s) is initiated by an order is posted or relinquished at an electronic commerce (eCommerce) online store 10 via the Internet 14 or by a telephone or written order posted at a catalogue dispatcher or trading company. The personal data of the ordering party (purchaser or calling subscriber) are queried by a corresponding Internet (eCommerce) application or by a telephone operator of the catalogue trading company and stored into a database. The ordering party is offered different product delivery models, e.g. delivery to its post address or delivery via lock box. The delivery model can be selected by the ordering party in the eCommerce application or the phone call or the order form. In addition, the ordering party receives information about where the good(s) can be fetched, i.e. which lock box and the code information which authorizes the ordering party to open the lock box and to obtain the good(s).

The lock box 34, 36, besides the shown connection to the online store 10, provides a continuous or temporary online or network connection also to other online offering companies or respective eCommerce server computers provided by them. This network connection enables data exchange between the lock box or the lock box installation, respectively, and the purchase offering companies and thus the herein described delivery system avoids and thus reduces costs for operating personnel for all of these companies.

Data which get exchanged are: Data of the recipient like name, address etc., code number to open the lock box, availability dates of the lock box from a lock box scheduler for the dispatcher, image of the inside of the lock box, weight data of the article, information of the purchase order and from the article.

To enhance security, the lock box installations can be safeguarded using a common video monitoring or alarm system. Further, one or more of the lock boxes of such an installation can comprise, as mentioned above, a cooling system for cooling frozen or perishable goods.

The described lock box can be set up at arbitrary places, e.g. at street corners, in stores like supermarkets. Thereby it can be guaranteed that e.g. end consumers can reach a lock box in their proximity and thus with minimum cost and time efforts. The underlying business process comprises a number of steps which are described in more detail in the following:

Placing an order for one or more articles by a purchaser or the calling subscriber (in the following called “ordering party”);

Fetching the home address of the ordering party and gathering an appropriate lock box installation from a lock box installation database in proximity to the home address;

Fetching article size information and/or information about perishability of the ordered article(s) from an article database and calculating a required lock box size and type;

Generating a lock box code number for the particular underlying order number and securely presenting that code number to the ordering party;

Calculating an expected delivery date, check and interlock with the lock box scheduler, and presenting the calculated delivery date together with the address and the number of the selected lock box to the ordering party (alternatively, the ordering party can determine a delivery date i.e. a date when to fetch the article(s) from the lock box);

Storing the order together with an order number and other data in an order database;

Presenting the stored order to the ordering party for confirmation of the purchase order;

Securely providing the ordering party with a personal identification number (PIN) for the initiated purchase order (can be identical with the code number used for opening the lock box) so that the ordering party can access the particular purchase order and change the delivery data afterwards;

Starting the necessary actions for delivery of the ordered article(s), in particular providing the stored purchase order information and the code number getting access to the particular lock box to a dispatcher service fetching the ordered article(s) from a third supplier or an own storehouse and dispatching the fetched article(s) to the particular lock box;

Automatically initiating a network or online connection from the lock box to the online shop to indicate in the online purchase order form accessible by the ordering party via the above PIN that the ordered article(s) has (have) been dispatched to the particular lock box;

The ordering party, having been informed of the dispatched article(s) via the above online purchase order form, at an arbitrary time goes to the lock box installation or facility indicated in the online purchase order form; a display in front of the lock box presents the name of the ordering party and after entering the code number, the article(s) can be fetched out of the lock box and the receipt confirmed by signature.

It should be noted that a credit card number of the ordering party can be used as code number wherein its correctness can be checked intermediately, i.e. in parallel. Further, the article(s) can be paid using a credit card only when fetching the article(s) from the lock box wherein the lock box will open only when the financial transaction has succeeded.

1. A method for computer supported delivery/distribution of goods after an order is placed using an ordering application or service of an online store by an ordering party comprising the steps of
instructing a dispatcher to process delivery of the ordered goods;
fetching the ordered goods from a storehouse by the dispatcher;
dispatching the fetched goods to a locking device;
providing a code number for accessing the locking device to the ordering party and transferring said code number to the locking device via a telecommunication channel; and
fetching the ordered goods from the locking device by the ordering party at an arbitrary time using said code number.

2. The method according to claim 1, further comprising the steps of
placing an order for at least one goods by the ordering party;
fetching the home address of the ordering party and selecting an appropriate locking device from a locking device database, in particular a locking device in proximity to said home address;
fetching common information about the ordered goods from an article database and calculating a required locking device size and/or type;
generating a locking device code number for the particular order and securely providing said code number to the ordering party; and
calculating an expected delivery date and providing the calculated delivery date together with information about the selected locking device to the ordering party.

3. The method according to claim 2, further comprising the further steps of:
storing the order together with an order number and/or other order information in an order database;
providing the stored order to the ordering party for confirmation of the order; and
securely providing the ordering party with a personal identification number (PIN) for the order so that the ordering party can access the order in said order database and change particularly the delivery data.

4. The method according to claim 1, wherein the locking device automatically initiates a network or online connection to the online store to indicate in the order stored in said order database, which is accessible by the ordering party via the said PIN, that the ordered goods have been dispatched to the particular locking device.

5. A system for computer supported delivery/distribution of goods after an order is placed using an ordering application or service of an online store by an ordering party, comprising
means for instructing a dispatcher to process delivery of the ordered goods;
locking means for dispatching the ordered goods; and
means for providing a code number for accessing the locking device to the ordering party and transferring said code number to the locking device via a telecommunication channel.

6. A locking device for use in a computer supported method of delivery /distribution of goods, comprising:
a box or a movable deposit system or an automatic storage system combined with a releasing counter means;
at least one lockable door which can be released electronically;
telecommunication means for providing a network or online connection to the online store and/or to other involved parties in the ordering process;
control means for handling information related to pending orders; and
converter means for interfacing between said at least one lockable door or movable deposit or automatic storage system, respectively, and/or said telecommunication means and/or said control means.

7. The Locking device according to claim 6, further comprising a display unit for viewing order information or the like.

8. The Locking device according to claim 7, wherein said display comprises a touch screen and/or write field for entering information, in particular a signature written by the ordering party when fetching the ordered goods from the locking device.

9. The Locking device according to claim 6, further comprising speech control means, in particular a speech output and/or speech input device, for supporting a dialog within the lock box system.

10. The locking device according to any of claim 6, further comprising a cooling means (110) for cooling the inside of the locking device.

11. The locking device according to claim 6, further comprising means for scanning and evaluating a barcode or the like, in particular in order to confirm placement of goods in the locking device by a dispatcher.

12. The Locking device according to any of claim 6, further comprising a card reader for reading credit cards or identity cards for authorization or/and for payment.

13. The locking device according to claim 6, further comprising a digital camera for checking correct delivery and/or light barriers for size check and/or correctness of delivery.

14. The locking device according to claim 6, further comprising an electronic libra for verification of correct delivery.

15. The locking device according to claim 6, further comprising a printer for printing a receipt and other delivery relevant information.

16. The locking device according to claim 6, further comprising an electronic movement indicator for implementation of a burglary alarm system.

17. The locking device according to claim 16, wherein said movement indicator is only activated when said at least one lockable door is opened through authorized access.

18. The locking device according to claim 6, wherein said telecommunication means, after placement of goods in the locking device by a dispatcher, initiates an online connection to the online store to inform the ordering party that the ordered goods have been dispatched.

19. The locking device according to claim 6, which is part of a locking device installation including locking devices of at least two sizes.
